(19) United States
(12) Patent Application Publication
(10) Pub. No.: US 2008/0080527 A1
(43) Pub. Date: Apr. 3, 2008

(54) METHOD AND APPARATUS FOR COMMUNICATION BETWEEN SESSION INITIATION PROTOCOL BASED NETWORKS AND LEGACY NETWORKS

(75) Inventor: Jheroen Dorenbosch, Paradise, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/536,750

(22) Filed: Sep. 29, 2006

(51) Int. Cl. H04L 12/56

(52) U.S. Cl. 370/401; 370/389

(57) ABSTRACT

A method and apparatus for passing a message at a gateway between a first network and second network. A message is received from the first network. Header information is added to the message indicative of an address associated with the gateway. Header information is added to the message indicative of an address associated with the first network. The message is forwarded from the gateway to the second network.

### FIELD OF THE INVENTION

The present invention relates generally to session initiation protocol (SIP) networks, and, more particularly, to the interaction of SIP networks with legacy networks.

### BACKGROUND

The Session Initiation Protocol (SIP) is a signaling protocol used for initiation and control of network user sessions. In some cases, the user sessions will involve the exchange of voice, video, or other data. SIP may be used among various SIP entities including SIP user agents and SIP proxies. SIP may be implemented over existing network infrastructures and in some cases is used only as a signaling protocol.

In some environments, a network may be operating or may implement SIP between SIP user agents. Such a SIP network may, at times, interact or exchange data with a legacy network that does not support or implement SIP. In some cases, the SIP user agents may attempt to exchange information with an entity that does not support SIP or that is accessed via a network that does not support SIP.

The SIP protocol allows for stateless proxies. In particular, stateless routing of a response to a request is facilitated by the use of Via headers. Each proxy that forwards the request adds itself to the Via headers in the request. The Via headers thus document the path taken by the request. The response can be routed back to the originator of the request by “unwinding” the Via headers. Each proxy that receives the response removes itself from the Via list and forwards the response using the address in the next Via header in the Via list. Thus the proxy does not need to remember where a request originated in order to route the response.

Gateways are often used between legacy networks or systems and SIP-based networks or systems. A legacy network is a network that uses a legacy protocol for signaling. A legacy protocol is a non-SIP protocol. A gateway provides protocol conversion for a request from an originator device in the legacy system and forwards it to the SIP-based system. Later the gateway provides reverse protocol conversion for the SIP response and forwards the converted response to the device in the legacy system. However, legacy protocols do not provide Via header functionality. Thus the gateway must retain state information in order to route the response to the originator of the request. Similarly, the gateway may later have to forward a request received from the SIP-based system to a device in the legacy system. This, again, requires that the gateway retains state information for the device.

What is needed is a system and method for addressing the above, and related, issues.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example messaging sequence in a SIP-based network.

FIG. 2 is an example response sequence in a SIP-based network.

FIG. 3 is an example message and response sequence between a legacy network and a SIP-based network in accordance with some embodiments of the invention.

FIG. 4 is an example message sequence between a legacy network and a SIP-based network having reduced state gateways in accordance with some embodiments of the invention.

FIG. 5 is an example message response sequence between a legacy network and a SIP-based network having reduced state gateways in accordance with some embodiments of the invention.

FIG. 6 is an example message and response sequence between a legacy network and a SIP-based network having reduced state gateways in accordance with some embodiments of the invention.

FIG. 7 is an example set of message and response sequences between a legacy network and a SIP-based network having reduced state gateways in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to communicating between SIP based networks and legacy networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of communicating between SIP based networks and legacy networks described herein. The non-processor circuits may include, but are not limited to, a radio receiver, a radio transmitter, signal drivers, clock circuits, power source circuits, and user input devices. As such, these functions may be interpreted as steps of a method to perform communication between SIP based networks and legacy networks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments are disclosed herein. For example, a method at a gateway between a first network and a second network of passing a message between the first network and the second network comprising is disclosed. The method includes receiving a message from the first network and adding header information to the message indicative of an address associated with the gateway. Adding header information to the message indicative of an address associated with the first network, and forwarding the message from the gateway to the second network is also disclosed.

A method of adapting a first, session initiation protocol (SIP) network for interaction with a second, legacy network having a second, legacy architecture is also disclosed. This method includes receiving a first message from the legacy network at the gateway and adding a first header to a first SIP message for the first message received from the legacy network, the first header including first header information providing an address associated with the legacy network. The method further includes adding second header information to the first SIP message, the second header information providing an address associated with the gateway, and forwarding the first SIP message to the first network.

Another embodiment includes a system for passing messages between a first, legacy network and a second, session initiation protocol (SIP) network providing a series of one or more stateless proxies is disclosed. The system includes a first network connection for interacting with the first, legacy network, a second network connection for interacting with the second, SIP network, and a gateway for passing messages between the first and second networks via the first and second network connections. A message received from the first network at the gateway is passed to the second network as an SIP request that comprises header information identifying the gateway and the first network.

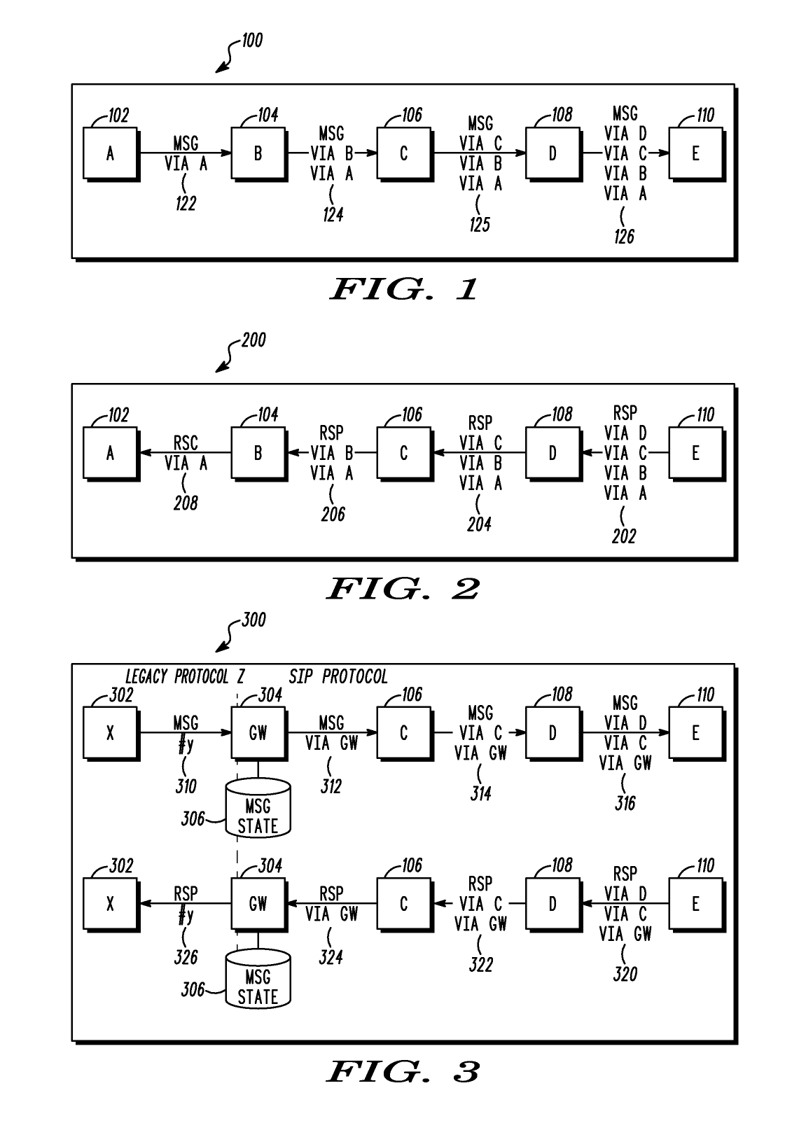

Referring now to FIG. 1, a prior example messaging sequence in a SIP based network in accordance with some embodiments of the invention is shown. The messaging sequence 100 illustrates one embodiment of a method for a number of SIP entities to propagate one or more request messages. A number of SIP entities 102, 104, 106, 108 and 110 are shown. These may be SIP proxies, SIP user agents or other SIP enabled entities. For purposes of discussion only, the SIP entities 102, 104, 106, 108 and 110 will be assumed to be SIP proxies. In other embodiments all or some of the SIP entities 102, 104, 106, 108 and 110 could be SIP user agents, SIP back-to-back user agents, SIP servers, SIP registrars or other SIP based entities. SIP proxy A 102 is shown sending a SIP message 122 to SIP proxy B 104. The SIP proxies may be stateless or may contain only minimal state information regarding messages that are passed. One technology used to deal with messages passed between stateless proxies is by the insertion of Via headers. As message 122 is passed from SIP proxy A 102 to SIP proxy B 104 a Via header is added. This header is shown in message 122 as the Via A header. In a similar fashion, as SIP proxy B 104 passes the message to SIP proxy C 106 (shown as message 124) an additional Via header is added. In message 124 its additional header is shown as the Via B header. As the message passes from SIP proxy C 106 to SIP proxy D 108 a Via C header is added as shown in message 125. As the message passes from SIP proxy D 108 to SIP proxy E 110 the message 126 is provided with an additional Via header corresponding to SIP proxy D 108, shown as the Via D header in message 126. In the manner described, each SIP proxy provides the message with an additional Via header which will later be used when the response for the message is forwarded back to the message originator. In FIG. 1 the SIP proxy A 102 may receive the message from a SIP user agent (not shown), or SIP proxy E 110 may provide the message to a SIP user agent (not shown) or there may be other SIP entities (not shown). It is understood that the messages shown in this and other figures are for illustration only and may contain additional headers and additional information in the message bodies.

Referring now to FIG. 2, an example response sequence in a SIP based network is shown. FIG. 2 corresponds to one method of sending a response message in a SIP based network. It can be seen that SIP proxies 104, 106 108 and 110 will be used to pass the response message back to the originator of the corresponding request message. A response 202 is shown being passed from the SIP proxy 110 to the SIP proxy 108. The return path of the response message 202 can be obtained by the SIP proxies 102, 104, 106, 108 and 110 by obtaining the Via header information that was inserted in the original message 122, 124, 125, 126 of FIG. 1. It can be seen that the response 202 contains the same Via headers as the original message 126. The SIP proxy E 110 forwards the response 202 to the SIP proxy D 108 obtaining the address of SIP proxy D 108 from the Via D header in the response 202. In a similar fashion, the SIP proxy D 108 forwards the response 204 to the SIP proxy C 106. The proper location for forwarding of the response 204 being obtained by the SIP proxy D 108 through the Via C header of the response 204. SIP proxy C 106 may obtain the location of the SIP proxy B 104 from the response 206. The SIP proxy B 104 obtains the location of the SIP proxy A 102 through the Via A header in the response 208. SIP proxy A 102 may forward the message to a SIP user agent (not shown) corresponding to the originator of message 122 in FIG. 1. Thus as has been described, SIP proxies and other SIP entities need not necessarily store state information corresponding to messages and responses in order to properly route such messages and responses through a SIP based network.

Referring now to FIG. 3, an example message and response sequence between a legacy network and a SIP based network in accordance with some embodiments of the invention is shown. As discussed in reference to FIGS. 1 and 2 a series of one or more SIP entities or SIP proxies 106, 108 and 110 may be interconnected on a network implementing SIP. Also shown in FIG. 3 is a legacy network X 302 corresponding to a network that does not or is not capable of implementing SIP. In such cases, a gateway 304 may be provided as an intermediary between the SIP network and the legacy network. The non-SIP compatible protocol implemented by the legacy network X 302 is referred to in FIG. 3 as legacy protocol Z. It can be seen from FIG. 3 that the gateway 304 is the demarcation point between the SIP network on the right and the legacy network 302 on the left. The gateway 304 may store state information corresponding to messages passed between the SIP network and the legacy network. This information may be stored in state information storage 306. In some embodiments the state information storage 306 may be a computer memory or other physical storage system capable of storing the requisite state information. In some embodiments, the gateway 304 functions as a proxy in the legacy network X 302 and uses a legacy protocol to communicate with other entities in the legacy network X 302. Similarly, the gateway 304 functions as a proxy in the SIP-based network using the SIP protocol to communicate within the SIP-based network.

Messages may pass from the legacy network X 302 into the SIP network via the gateway 304. One such message is shown as message 310. When the gateway 304 receives the message 310 from the legacy network 302, state information corresponding to message 310 may be stored in the state information storage 306. When the message has entered the SIP network through the gateway 304, the gateway 304 attaches a Via header to the message as shown by message 312. The message received by SIP proxy C 106 receives an additional Via header shown in message 314 before being passed to SIP proxy D 108. Similarly SIP proxy D 108 provides an additional Via header as shown in message 316 before the message is passed to SIP proxy E 110. As with FIG. 1, the SIP proxy E 110 may provide the message to a SIP user agent (not shown) or there may be other SIP entities (not shown).

As shown in the lower half of FIG. 3, when a response corresponding to the initial message is passed back through the SIP proxies 106, 108 and 110, the added Via headers may be removed and/or used to determine the proper path for the response. The SIP proxy D 108, upon receiving the response 320 from SIP proxy E 110, may remove its own Via header and obtain the location of SIP proxy C 106 and pass the response 322. SIP proxy C 106 determines the gateway as the next location for the response based upon the Via header entered into the request by the gateway and forwards the response 324 to the gateway 304. The gateway, having stored state information corresponding to the original message 310, may retrieve the state information stored in the state information storage 306 to determine the correct location to route the response 326 back to the legacy network 302. Thus, it can be seen that FIG. 3 describes one process for allowing a SIP based network to interact with a legacy network through the use of one or more gateways storing state information corresponding to messages and/or responses.

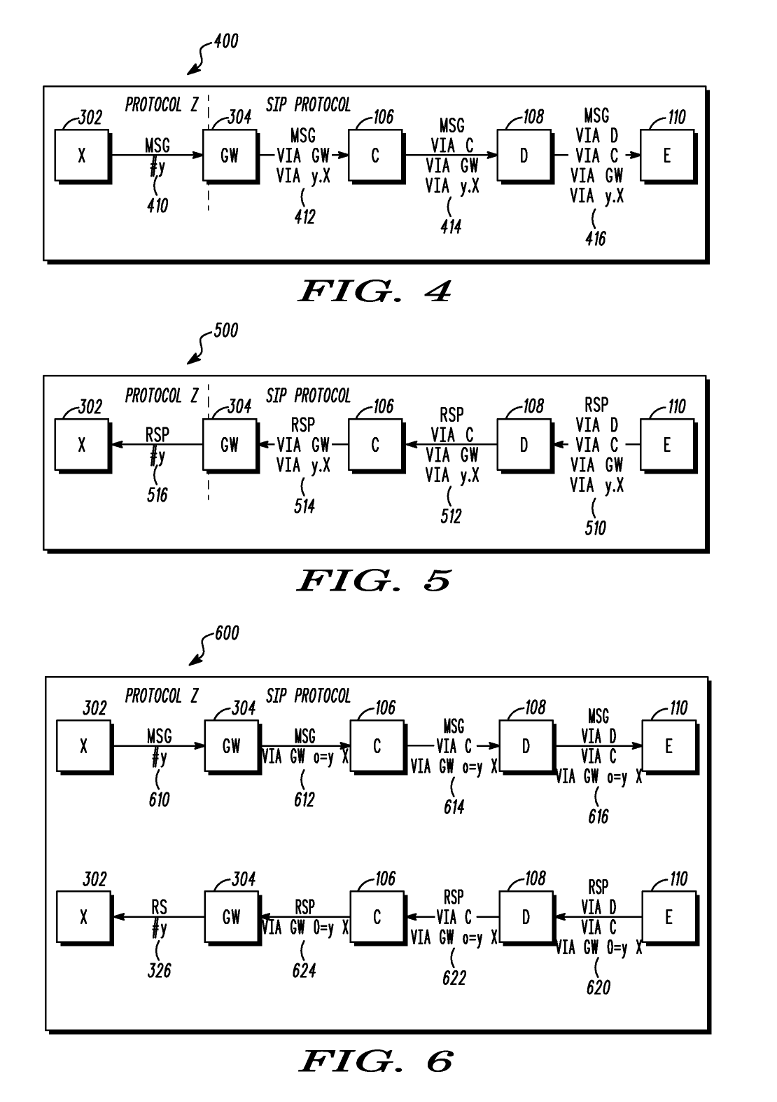

Referring now to FIG. 4, an example message sequence between a legacy network and a SIP based network having reduced state gateways in accordance with some embodiments of the invention is shown. The message sequence 400 of FIG. 4 corresponds to one embodiment of a method for allowing a SIP based network to interact with a legacy network X 302 through a gateway 304, while allowing the gateway 304 to store a reduced amount of state information corresponding to the messages. The gateway 304 is shown without state information storage 306 for illustrative purposes. However, it is understood that the gateway 304 may have a memory or storage system associated therewith and may store at least some state information, such as the gateway's own address. The legacy network X 302 passes the message 410 to the gateway 304. As was described with respect to FIG. 3, the gateway 304 may insert a Via header corresponding to the gateway into the message 412 before it is passed to the remainder of the SIP network such as SIP proxy C 106. However, in the embodiment shown in FIG. 4, an additional Via header, shown in message 412 as Via Y.X in message 412 is inserted. This additional Via header may correspond to the state information that the gateway 304 may otherwise store regarding the message 410 passed from the legacy network X 302, as was shown earlier in FIG. 3. In some embodiments, this additional Via header (and possibly others) may include a predetermined special value that identifies the header as being extra. The message 412 may proceed through the SIP network to the recipient as described above. As shown by message 414 and 416, the original message may continue to obtain additional Via headers as the message propagates through the SIP based network to and eventual SIP user agent.

Referring now to FIG. 5, an example message response sequence between a legacy network and a SIP based network having reduced state gateways in accordance with some embodiments of the invention as shown. The message response sequence shown in FIG. 5 corresponds to a response being sent through the SIP network to the legacy network X 302 in response to the request message passed as described in FIG. 4. As the response 510 propagates through the series of SIP proxies 106, 108 and 110, the return path for the response can be obtained by the proxies from the Via headers added in the original message transmission. These can be seen in FIG. 5 in the response messages 510, 512 and 514. When the response 514 is forwarded from the SIP proxy C 106 to the gateway 304, the gateway may obtain the needed state information to send the response 516 from the additional Via header, Via Y.X in the response 514. Once the correct state information has been obtained by the gateway 304, the response 516 may be sent to the proper entity in the legacy network X 302. Thus FIGS. 4 and 5 illustrate one possible method for messages and responses to be sent between a legacy network and a SIP based network utilizing gateways storing reduced amounts of state information.

Referring now to FIG. 6, an example message and response sequence between a legacy network and a SIP based network having reduced state gateways in accordance with some embodiments of the invention is shown. The message and response sequence 600 of FIG. 6 illustrates another way in which the gateway 304 can use one or more Via headers to store at least part of the state information needed for handling messages and responses to the legacy network 302. As before, a message is received at the gateway 304 from legacy network X 302. This is shown in FIG. 6 as message 610. The gateway 304 receives the message and inserts a Via header corresponding to the gateway 304 into message 612. In addition to the Via header information corresponding to the gateway 304, the gateway 304 inserts information about the originator of the message in the legacy network 302 using a Via extension parameter. The inserted information will be carried with the request and returned to the gateway in the response as will be described. Message 612 is shown containing the Via header containing Via header information corresponding to the gateway as well as the Via extension parameter corresponding to at least part of the state information associated with the original message 610 as received from the legacy network 302. The message 612 containing the Via header added by the gateway and the Via extension parameter may then be passed to the remainder of the SIP based network such as the SIP proxies 106, 108 and 110. As before, as the message propagates between the SIP proxies additional Via headers may be added which correspond to the SIP proxy handling the message. These additional Via headers can be seen, for example, in the messages 614 and 616. Similarly, when the response is received from the recipient SIP entity, it may be routed back to the originator by the SIP proxies 106, 108 and 110 by obtaining routing information from the added Via headers. The Via headers may be removed as the response is passed back to the SIP network as is shown in responses 620, 622 and 624. When the SIP proxy C 106 forwards the response 624 back to the gateway 304, the gateway may obtain the information needed to properly deliver the response back to the legacy network 302 by reading the Via extension parameter included in the original message 612. As can be seen, the response 624 will also contain the Via extension parameter when it is returned to the gateway 304. The gateway 304 may remove the added Via header and extension parameter before forwarding the message 626 back to the appropriate entity in the legacy network 302.

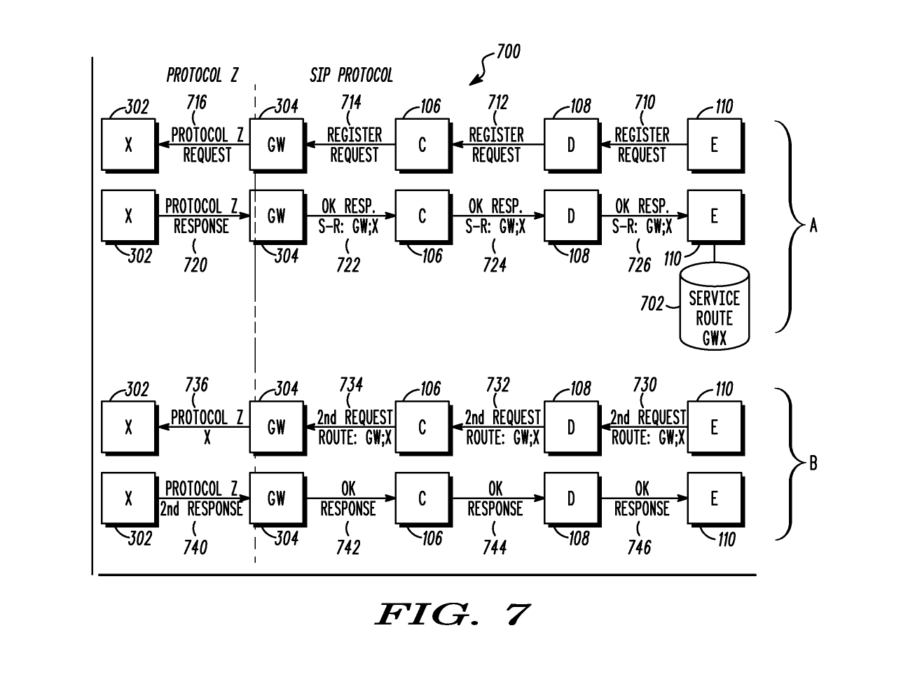

Referring now to FIG. 7, an example set of message and response sequences between a legacy network and a SIP based network having reduced state gateways in accordance with some embodiments of the invention is shown. The example set of message and response sequences 700 shown in FIG. 7 can be divided into message and response set A and message and response set B. Beginning with message and response set A, a register request 710 (or another type of request) may originate from somewhere within the SIP based network. In the example provided in FIG. 7, the register request 710 is shown as originating from SIP proxy E 110 although it is understood that the register request 710 may actually originate elsewhere. The request is passed to SIP proxy D 108 and then to SIP proxy C 106 as register request 712 and on to the gateway 304 as register request 714. As discussed above, Via headers may be added to the request by the SIP proxies E 110, D 108, and C 106. The gateway 304 forwards the request in the appropriate protocol corresponding to the legacy network 302. A response 720 may be received at the gateway 304 from the legacy network X 302. This response may be a response in the protocol Z corresponding to the legacy network 302. The gateway 304 forwards the response as an “OK” response 722. The ‘OK’ response is a response based on the SIP protocol and will be passed to the SIP proxies 106, 108 and 110. Before forwarding the response 722, the gateway 304 may insert a service route header. The service route header is shown in the response messages 722, 724 and 726 as they propagate between the SIP proxies 106, 108 and 110. The service route header may include the address of the gateway 304. Additionally, the service route header may include information indicative of an address associated with the legacy network X 302. The information indicative of an address associated with the legacy network X 302 may be included, for example, the user name part of the address of the gateway 304, or in a parameter added to the service router header. The information indicative of an address associated with the legacy network X 302 may be an address of a device in the legacy network, an SIP address of Record representing a device in the legacy network, or an identifier used by a device in the legacy network. An SIP Address of Record may represent a device in the legacy network by including the address or an Identifier of the device. The service route header may be stored by one or more entities in the SIP based network such as the SIP proxy E 110. It may be stored in the memory associated with the SIP proxy E 110, such as the memory 702. It is understood that a memory 702 may also be associated with a SIP user agent or another point within the SIP based network needing to store service route information.

As can be seen in the message set B, the SIP proxy E 110 or other SIP entity may send a request 730 that includes the route information that was originally contained in the service route header. The request propagates through the SIP proxies 106, 108, 110 and possibly other SIP entities within the SIP network as shown by the request 730, 732 and 734. When the request 734 reaches the gateway 304, the gateway may obtain the appropriate routing information for forwarding the request to the legacy system from the included routing information that was originally provided by the service route header in message sequence A. The gateway 304 may then proceed to provide the request to the appropriate entity in the legacy network 302 as shown by the message 736, encoded in protocol Z associated with the legacy network X 302. A second response may be provided in the protocol Z associated with the legacy network 302 as shown by the second response 740. The gateway 304 may convert the response that is based upon the protocol Z associated with the legacy network 302 into a SIP based response such as the “OK” response 742. As can be seen, the response may propagate through the SIP entities associated with the SIP based network such as the SIP proxies 106, 108, and 110 using Via header information. As shown by the ‘OK’ responses 742, 744 and 746, the ‘OK’ response will arrive back at the originating entity. From the foregoing, it will be appreciated that the current method allows the gateway to route the second request without the use of stored state information indicating and address associated with the legacy network X 302.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method at a gateway between a first network and a second network of passing a message between the first network and the second network, the method comprising:
receiving a message from the first network;
adding a first Via header information to the message indicative of an address associated with the gateway;
adding a second Via header information to the message indicative of an address associated with the first network; and
forwarding the message from the gateway to the second network.

2. The method of claim 1, wherein adding the fist Via header information to the message indicative of an address associated with the gateway further comprises adding a first Via header to a session initiation protocol (SIP) request; and
wherein adding the second Via header information to the message indicative of an address associated with the first network further comprises adding a second Via header to a session initiation protocol (SIP) request.

3. The method of claim 1, wherein adding the first Via header information to the message indicative of an address associated with the gateway and adding the second Via header information to the message indicative of an address associated with the first network are accomplished by adding a Via header and a Via extension parameter to a session initiation protocol (SIP) request.

4. The method of claim 1, wherein forwarding the message from the gateway to the second network comprises receiving a legacy protocol message and sending a session initiation protocol (SIP) message.

5. The method of claim 1, wherein adding the second Via header information to the message indicative of an address associated with the first network further comprises adding a header to a session initiation protocol (SIP) response.

6. The method of claim 1, further comprising:
pursuant to forwarding the message, receiving a second message at the gateway from the second network;
obtaining Via header information from the second message indicative of the address associated with the first network; and
forwarding the second message to the first network using the address associated with the first network.

7. A method at a gateway between a first network and a second network of passing a message between the first network and the second network, the second network being a legacy network, the method comprising
receiving a message at a first network;
adding a first service route information to the message indicative of an address associated with the gateway;
adding a second service route information to the message indicative of an address associated with the first network;
forwarding the message from the gateway to the first network;
pursuant to forwarding the message, receiving a second message at the gateway from the second network;
obtaining service route information from the second message indicative of the address associated with the first network; and
forwarding the second message to the first network using the address associated with the first network.

8. The method of claim 7, wherein receiving the second message from the second network further comprises receiving a session initiation protocol (SIP) message.

9. The method of claim 7, wherein obtaining service route information from the second message indicating the address associated with the first network further comprises obtaining a Route header from a session initiation protocol (SIP) request.

10. The method of claim 9, wherein obtaining service route information from the second message indicative of the address associated with the first network further comprises obtaining the second service route information from the Route header.

11. A method of adapting a session initiation protocol (SIP) network for interaction with a legacy network having a legacy architecture, the method comprising:
receiving a first message from the legacy network at the gateway;
adding a first header to a first SIP message for the first message received from the legacy network, the first header including first header information providing an address associated with the gateway;
adding second header information to the first SIP message, the second header information providing an address associated with the legacy network; and
forwarding the first SIP message to the first network.

12. The method of claim 11, further comprising receiving a second SIP message from the SIP network, the second SIP message including the second header information providing an address associated with the legacy network and the first header information providing an address associated with the gateway.

13. The method of claim 12, further comprising obtaining the address associated with the legacy network from the second header information included in the second SIP message.

14. The method of claim 13, further comprising forwarding the second SIP message to the legacy network using the address associated with the legacy network obtained from the second header information.

15. The method of claim 12, wherein the first header is a Via header.

16. The method of claim 12, wherein the first header is a service route header.

17. A system for passing messages between a first, legacy network and a second, session initiation protocol (SIP) network providing at least one stateless proxy, the system comprising:
a first network connection for interacting with the first, legacy network;
a second network connection for interacting with the second, SIP network;
a gateway for passing messages between the first network via the first network connection and the second network via the second network connection;
wherein a message received from the first network at the gateway is passed to the second network as an SIP request that comprises header information identifying the gateway and header information identifying at least one address associated with the first network.

18. The system of claim 17, wherein the header information identifying the gateway and the header information identifying at least one address associated with the first network are each contained in a separate Via header.

19. The system of claim 17, wherein the header information identifying the gateway comprises a Via header and the header information identifying the first network comprises a Via extension parameter in the Via header.

20. The system of claim 17, wherein the header information identifying the gateway and the first network comprises a first Via header including a predetermined special value identifying the Via header as an extra Via header.
